(19) United States
(12) Patent Application Publication
(10) Pub. No.: US 2025/0002411 A1
(43) Pub. Date: Jan. 2, 2025

(54) METHOD FOR PRODUCING SUPPLEMENTARY CEMENTITIOUS MATERIAL

(71) Applicant: Cemgreen APS, Hobro (DK)

(72) Inventors: Lasse Norbye Dossing, Roskilde (DK); Martin Hagsted Rasmussen, Lübeck (DE); Mogens Juhl Fons, Farup (DK)

(73) Assignee: Cemgreen APS, Hobro (DK)

(21) Appl. No.: 18/846,603

(22) PCT Filed: Mar. 16, 2022
(86) PCT No.: PCT/EP2022/056855

§ 371 Date: Sep. 12, 2024

(51) Int. Cl. C04B 20/04; C04B 28/02

(52) U.S. Cl. CPC C04B 20/04; C04B 28/02

(57) ABSTRACT

The present invention concerns a method for producing a supplementary cementitious material, comprising the steps of nodularizing a raw material of the supplementary cementitious material to produce nodules having an average particle size of 1 to 500 mm; and calcining the nodules, wherein the calcining is conducted by passing gas, having a temperature in the range of 400 to 800° C., through a bed of nodules, without the nodules becoming entrained in the gas. Further, the invention concerns a method for producing a cement comprising milled cement clinker and a supplementary cementitious material, wherein the supplementary cementitious material is produced by the inventive method, and wherein the milled cement clinker is produced by a clinkerization process, comprising the steps of calcining and subsequently milling a limestone-based raw material.

The invention relates to a method for producing a supplementary cementitious material, and to a method for producing a cement.

### BACKGROUND

Cement is used world-wide in huge amounts e.g. as a binder in concrete. One major raw material for producing cement is limestone (CaCO₃). Naturally occurring limestone is first crushed into small pieces in the quarry and then transported to the cement production site. Said small pieces are ground or milled at the cement production site usually to a size of approximately 1 to 100 μm. The resulting limestone powder is mixed with an aluminum containing raw material and then injected into a pre-heater, wherein the mixture is heated to about 800° C. Subsequently, the mixture is injected into a rotary kiln, wherein the temperature is gradually raised to at least 1450° C., whereby the cement clinker is formed. As the melt continues out of the kiln, it cools and agglomerates in small nodules called clinker, having a particle size of 1 to 50 mm. These clinkers are subsequently mixed with gypsum (CaSO₄) and ground again into fine powder, the so-called milled cement clinker. Said milled cement clinker usually has an average particle diameter of 1 to 100 μm.

The transformation of limestone to CaO liberates significant amounts of CO₂, typically 0.8 kg CO₂ per kg produced clinker. The total production of cement is around 4 gigatons per year, resulting in a total CO₂ emission that accounts for about 8% of the global CO₂ emissions. Cement production is also very energy consuming, increasing the associated CO₂ footprint further. The high CO₂ footprint is unwanted and has been linked to climatic change. The increased demand of cement causes an urgent need to increase the cement production capacity while reducing at the same time the CO₂ emissions associated with the production of the cement clinker.

One approach of increasing the cement capacity while simultaneously reducing the CO₂ emissions is to partially replace the clinker by a supplementary cementitious material (SCM). Several supplementary cementitious materials have been tested and are commercially used. Examples are e.g. fly ash or ground granulated blast furnace slag. However, the use of these supplementary cementitious materials is limited by their availability. Further, the mechanical properties of the resulting cement are in any case somewhat inferior, when compared to non-supplementary cements, such as Portland type cement.

Further approaches are known that employ clay, shale, slate or mudstone materials as supplementary cementitious materials. In general, such materials are natural geologic materials that are formed during sedimentation in a water column. Naturally occurring clay, shale, slate or mudstone minerals have a very low pozzolanic activity, which is necessary to achieve good mechanical cement properties. However, the pozzolanic activity can be induced by heat treating the minerals, which results in the removal of hydroxyl groups. Conventional processes usually involve a milling/grinding of the clay, shale, slate or mudstone materials prior to the heat treatment. Further, naturally occurring clay, shale, slate or mudstone material deposits have a varying quality concerning their amount of pozzolanically active minerals, their water content and their particle size.

The international patent application PCT/EP2020/081722 discloses methods for producing a cement comprising a supplementary cementitious material, wherein the cement can be produced with reduced CO₂ emission and energy consumption, shows a high substitution rate of the milled cement clinker and has a reduced unwanted discoloration and increased mechanical properties, such as compressive strength, when compared to other substituted cements. However, these methods require a rather high calcining temperature of up to 980° C., which in turn increases the production costs for producing cements with these conventional methods. Moreover, the color properties and the mechanical properties, such as the compressive strength, of the resulting cement may vary significantly and are further improvable.

Analogous considerations apply to WO2012/126696A1, which discloses a method for producing a clinker substitute for use in the cement production comprising the steps of pre-drying clay, comminuting the clay to a grain size of smaller than 2 mm, calcining the clay at a temperature of up to 1000° C., treating the clay under reducing conditions at a temperature of up to 1000° C., intermediate cooling and final cooling of the product. A major disadvantage of this method is that it requires that the raw material is calcined at a very high temperature. Moreover, this method requires the step of treating the clay under reducing conditions in order to ensure a sufficient color of the resulting cement and is thus further improvable.

DE102010061456A1 discloses a method for producing a building material composition, which is provided as a part of a binder or as a part of building material mixture with a binding agent, wherein the method comprises the steps of (i) coarsely grinding a raw clay material, such that at least 90% of the particles comprise a particle size of at most 100 mm, and/or preferably at least 70% of the particles have a particle size of at least 10 mm, and/or that at least 90% of the particles have a particle size of at least 1 mm; (ii) calcining the coarsely grinded raw clay material at a temperature range of up to 950° C., and (iii) milling the calcined particles in that 90% to 99% of the particles have a particle size of smaller than 32 μm. Further, this document discloses a binding agent composition comprising a cement. However, this method cannot produce supplementary cementitious materials that can be produced with a high and consistent quality from a huge variety of raw materials. Further, the energy costs are rather high due to the high calcining temperatures. The high calcining temperatures also may lead to an unwanted discoloration of the material.

The conventional methods for producing supplementary cementitious materials often use raw material powders with a rather small particle size during the calcining process, and rather high calcining temperatures, which is associated with the disadvantages as identified above.

One approach for pre-treating powder-like raw materials prior to calcining is well known in the industry and refers to the production of Lightweight Expanded Clay Aggregates (LECA). An overview of LECA materials is given in the scientific publication “Alaa M. Rashad, Construction and Building Materials 170 (2018), 757-775. In general, LECA are produced from clays with a high water content. The clay is dried, heated and burned in a rotary kiln at temperatures of approximately 1100 to 1300° C. During heating, gas is released inside the pellets and entrapped in it during cooling, whilst the organic compounds are burned off, forcing the pellets to expand, producing ceramic pellets of a porous, lightweight and high crushing resistant material. LECA pellets expand up to five to six times. LECA particles are round due to the circular movement during heating in the rotary kiln. Inside LECA particles, there are holes of different sizes, which are mostly interconnected. Other types have different structures and geometries. This depends on the production process, of which increasing temperature during sintering leads to an increase in porosity. The LECA particles that are produced prior to calcining are in the form of so-called “nodules.” However, the LECA materials require a calcination at elevated temperatures of above 1000° C., which leads to a vitrification of the clay minerals. Thus, LECA materials are unsuitable to act as supplementary cementitious materials in the cement production, since these materials would not undergo a pozzolanic reaction in the final cement.

Further, the calcination of raw materials of supplementary cementitious materials may be commonly conducted in conventional rotary kilns for producing cement. In such a process, the calcination is achieved by flowing hot gas with a temperature of up to 1000° C. over a bed of granular raw material, while the granules are conveyed and rotated. However, such a process also requires rather high temperatures due to the low gas to solid heat transfer coefficient and thus is disadvantageous from an economic point of view. Further, the resulting cement shows an unwanted discoloration.

Overall, the conventionally known methods for producing supplementary cementitious materials are still insufficient with regard to the energy consumption of the production process and with regard to the properties of the supplementary cementitious material. In turn, there exists a strong need for the provision of a method for producing a supplementary cementitious material in an economic and cost efficient way on a large scale, wherein the supplementary cementitious material can be employed for producing a cement having a reduced discoloration but still sufficient mechanical properties, such as compressive strength.

### PROBLEM OF INVENTION

In view of this, a problem to be solved by the present invention is the provision of a method for producing a supplementary cementitious material, which can produce the supplementary cementitious material in a high and consistent quality, with low production costs and on a large-scale. Moreover, the resulting supplementary cementitious material can be used in the production of a cement with improved color properties, such as a reduced unwanted discoloration, and sufficient mechanical properties, such as compressive strength.

Further, a problem to be solved by the present invention is the provision of a method for producing cement comprising milled cement clinker and a supplementary cementitious material, which can reduce the CO₂ emission and energy consumption, which allow a highly flexible process and a high substitution rate of the milled cement clinker, and which lead to a cement with improved color properties, such as a reduced unwanted discoloration, and with sufficient mechanical properties, such as compressive strength.

### BRIEF DESCRIPTION OF INVENTION

This problem is solved by the method for producing a supplementary cementitious material in accordance with claim 1. Preferred embodiments of the method are defined in claims 2 to 13. Further, this problem is solved by the method for producing a cement in accordance with claim 14. A preferred embodiment of the method for producing a cement is defined in claim 15. All preferred embodiments are also encompassed in combination.

### FIGURES

The present invention and its advantages are illustrated by the following figures:

FIG. 1 illustrates a longitudinal section view of an exemplary device for conducting a method in accordance with the present invention.

FIG. 2a illustrates a perspective view of a first and second step of one of the gas temperature adjustment systems of the device shown in FIG. 1.

FIG. 2b illustrates a longitudinal section of the perspective shown in FIG. 2a.

FIG. 3 illustrates a perspective view of several grate plates of a sloped sliding surface of an exemplary device mounted on several supports.

FIG. 4 illustrates a perspective view of a support as shown in FIG. 3 without insulation.

FIG. 5a illustrates a perspective view of a first and second step of a gas temperature adjustment system of an exemplary embodiment of the device.

FIG. 5b illustrates a longitudinal section of the perspective shown in FIG. 5a.

FIG. 6a illustrates a perspective view of a first and second step of a first gas temperature adjustment system and a first and second step of a second gas temperature adjustment system of an embodiment of the device.

FIG. 6b illustrates a longitudinal section of the perspective shown in FIG. 6a.

FIG. 7a illustrates a perspective view of another embodiment of the device.

FIG. 7b illustrates a side view of an embodiment of the device shown in FIG. 7a.

FIG. 7c illustrates a longitudinal section A of the embodiment of the device shown in FIGS. 7a and 7b.

FIG. 8 illustrates a longitudinal section of a further embodiment of the device.

FIG. 9 shows the theoretical relationship of the critical gas velocity as a function of the particle diameter and the superficial gas velocity.

### DETAILED DESCRIPTION OF INVENTION

### General Definitions

The term “supplementary cementitious material” (or “SCM”) is defined as a material, with which cement can be substituted, i.e. partially replaced. Suitable supplementary cementitious materials may be in embodiments derived from raw materials that are selected from the group comprising clay, soil, marine clay, mudstone, claystone, shale, slate, mine tailing, oil sand and harbor sludge materials, or combinations thereof. The raw materials supplementary cementitious materials in terms of the present invention comprise in embodiments at least 20 wt. %, preferably at least 40 wt. %, clay minerals. The clay mineral content can be determined by e.g., a suitable method for measuring the acid soluble residue and/or by quantitative X-ray diffraction.

Clay materials constitute a preferred embodiment for the raw material for the supplementary cementitious material. The clay materials in terms of the present invention are defined as materials preferably comprising clay minerals belonging to the kaolin group, the smectite group, the illite group, chlorite group or combinations thereof. Suitable clay minerals of the kaolin group are e.g. kaolinite, dickite, nacrite or halloysite. Suitable further clays minerals belong to the smectite group including octahedral vermiculites such as vermiculite, dioctahedral smectites such as montmorillonite and nontronite and trioctahedral smectites such as saponite, the illite group such as illite, glauconite and brammallite or to the chlorite group such as chamosite. In nature, clay minerals are found either as loose wet sediments/soils (clay) or as a dry rock (shale).

The supplementary cementitious material usually comprises in embodiments oxidizable components, such as Fe, Cr, Ti, Cu, U or Mn components. The Fe content is preferably 0.500 to 20.000 wt. %. The Cr content is preferably 0.010 to 5.000 wt. %, the Ti content is preferably 0.100 to 5.000 wt. %, the Cu content is preferably 0.001 to 0.010 wt. %. The U content is preferably 0.001 to 0.100 wt. %. The Mn content is preferably 0.010 to 1.000 wt. %. The content is preferably measured with an X-ray fluorescence (XRF) spectrometer or alternatively with an inductively coupled plasma mass spectrometer (ICP-MS). These oxidizable components may cause an unwanted discoloration, when they are present at the surface of the particles during calcining.

The term “calcining” refers to a thermal treatment, usually in the presence of gas containing less oxygen than ambient air, of a given raw material in order to achieve a chemical decomposition. The calcination degree can be determined by thermogravimetry and/or DTA (e.g. Bich et al., Applied Clay Science, 44 (2009) 194-200).

The term “dehydroxylation” refers to the at least partial loss of one or more hydroxyl groups as water upon heating. A dehydroxylation of the raw material of the supplementary cementitious material is achieved during calcining.

The term “pozzolanic activity” means that the supplementary cementitious material can act as a pozzolan in the cement. Pozzolanic activity is in generally known as the ability to chemically react in the presence of water with calcium silicate hydrate at ordinary temperature in order to form compounds possessing cementitious properties.

The term “vitrification” is defined as the occurrence of melting phases and the formation of inert minerals, such as mullite, that is associated with an agglomeration of the particles, in the supplementary cementitious material. Vitrification takes place at elevated temperatures of 1000° C. or higher and is to be avoided as much as possible, since it reduces the pozzolanic activity of the calcined material. In this regard, reference is made to the scientific publication “Investigation of the Effect of Heat on the Clay Minerals Illite and Montmorillonite, R. E. Grim and W. F. Bradley, Journal of the American Ceramic Society, 1940, Vol. 23, No. 8, 242-248), which clearly states that the calcining temperature of the clay materials must not exceed 980° C. in order to prevent the occurrence of vitrification.

The term “milling” in terms of the present application is used as a synonym for crushing/grinding and defines a physical process of forming particles from a solid raw material and/or of reducing the particle size of a particulate raw material. Milling means are commonly known and are e.g. roller press, ball mill, vertical roller mill, dry crusher and jaw crusher.

The term “average particle size” in terms of the present application is defined as the arithmetic average particle size as measured according to ASTM C 430-96 (2003).

The term “nodularizing” is defined as a step of forming a raw material by e.g. crushing, milling, pelletizing, agglomerating, compressing or molding, into the shape of a nodule. A nodule in terms of the present application is a mostly irregular rounded knot, granule, mass or lump of a mineral aggregate. Nodules, granules or pellets are interchangeably used in terms of the present application.

### Method for Producing Supplementary Cementitious Material

A method for producing a supplementary cementitious material in terms of the present invention comprises the steps of nodularizing a raw material of the supplementary cementitious material to produce nodules having an average particle size of 1 to 500 mm, and calcining the nodules, wherein the calcining is conducted by passing gas, having a temperature in the range of 400 to 800° C., through a bed of nodules, without the nodules becoming entrained in the gas.

The method essentially comprises a step of nodularizing the raw material of the supplementary cementitious material prior to the calcining step to produce nodules having an average particle size of 1 to 500 mm. The average particle size is the average size of the nodules in the X, Y and Z dimensions. In preferred embodiments, the nodules have an average particle size of 2.5 to 400 mm, preferably 5 to 300 mm, more preferably 10 to 250 mm.

Nodularizing processes and devices are not restricted and are a commonly known. The nodularizing processes and devices may be appropriately selected, depending on the nature of the starting material, such as its particles size and/or its water content.

For instance, nodules can be either prepared from powders or fine particles having a particle size that is smaller than that of the resulting nodules. In this case, the nodularizing processes and devices involve the aggregation or combination of two or more starting particles that form the nodule. Alternatively, the nodules can be made from paste-like starting materials by e.g., extrusion, or pelletizing and subsequent portioning to nodules, or by grinding, or crushing larger particles.

Further, appropriate nodularizing processes and devices may be selected on the basis of the water content of the starting material. Suitable processes and devices for forming nodules are commonly known. In general, the devices can be classified in non-pressure devices and pressure devices. Non-pressure devices are suitable, when the nodules are held together without any pressure by using a binder, such as water. Pressure device are suitable, when the nodules are formed by pressurizing. A binder might be optionally used in such pressure devices, but is not mandatory. For example, the following devices may be used:

A disc pan pelletizer can form nodules by a rotating disc by adding water to the material as binder and is applicable for dry materials. A rotary drum pelletizer can form nodules in a rotary drum, wherein a binder, like water, is added. A pug mil is a device, wherein the raw material is extruded through a matrix and cut off in the right size. A pin mixture is a nodularizing device, which is similar to a rotary drum, but where the central shaft is equipped with pins. A screen feeder is a device, wherein the raw material is forced through a screen, which is terminating the nodule size. These devices are none-pressure devices.

Suitable pressure devices are either a briquetter, wherein the material is pressed together, or a compactor, wherein the material is pressed together between rows (which might be equipped with pattern). In addition, also any other method for forming nodules, which is known in the art, can be used.

In a preferred embodiment, the nodules are produced by a non-pressure nodularizer, such as pug mill, or by a pressure nodularizer, such as a briquetter or a compactor.

The step of nodularizing the raw material of the supplementary cementitious material optimizes the raw material of the supplementary cementitious material, and has several advantages. For instance, the production of nodules particularly ensures that the supplementary cementitious material can be handled easily and can be produced in a high and consistent quality, with low production costs and on a large-scale. Moreover, the resulting supplementary cementitious material can be used in the production of a cement with particularly improved color properties and mechanical properties, such as compressive strength.

These particularly improved effects cannot be achieved in conventional methods, which involve the calcining of powders or smaller particles with an average particle sizer of smaller than 1 mm. For instance, it is easier and cheaper to work with nodules, when compared to powders or smaller particles. Moreover, the risk of overheating nodules is less than the risk of overheating a powder with a smaller particle size, which minimizes discoloration of the resulting SCM product, and which increases the chemical properties of the resulting cement, such as the compressive strength. On the other hand, it is also disadvantageous to employ particles having an average particle size of higher than 500 mm. In such a case, the production of a supplementary cementitious material in a high and consistent quality cannot be achieved. Further, it is difficult to run the process with low production costs and on a large-scale. Nodularizing can be further done with wet and with dry raw materials.

Subsequently to the nodularizing step, the inventive method essentially comprises a step of calcining the nodules. The calcining step must be conducted in a specific way.

Firstly, the calcining step is conducted by passing gas through a bed of nodules. The term “bed of nodules” in terms of the present invention means a layer of nodules, which are in contact with each other. The thickness of the bed is not limited. However, the bed of nodules may have in embodiments a thickness of 500 cm or less, preferably 250 cm or less, more preferable 100 cm or less. The term “passing gas through a bed of nodules” means that the gas passes through the bed in a way that each nodule in the bed comes in contact with the gas. In embodiments, the gas passes the bed of nodules in a transversal direction in relation to the bed. The term “transversal direction” means that the flow direction of the gas in predominately perpendicular to the main direction of the bed of nodules. The nature of the gas is not limited. The gas is preferably air. However, also inert gases, such as nitrogen or CO₂, are suitable.

Secondly, the calcining is conducted in a way that the gas has temperature in the range of 400 to 800° C., when it passes the bed of nodules. The temperature of the gas range constitutes the maximum calcining temperature of the nodules.

Thirdly, it is essential that the passing of the gas through the bed of nodules is conducted in a way that the nodules do not become entrained in the gas. In other words, the position of the nodules in the bed is not affected or altered by the gas that passes through the bed. Such situation can be achieved by appropriately adjusting relevant process conditions and parameters, such as the gas velocity, the particle size, the material density and the shape of the particles. Suitable process conditions and parameters in order to avoid an entrainment are either known to a person skilled in the art, are easily determinable by routine experiments, or are predictable on the basis of theoretical mathematical estimations.

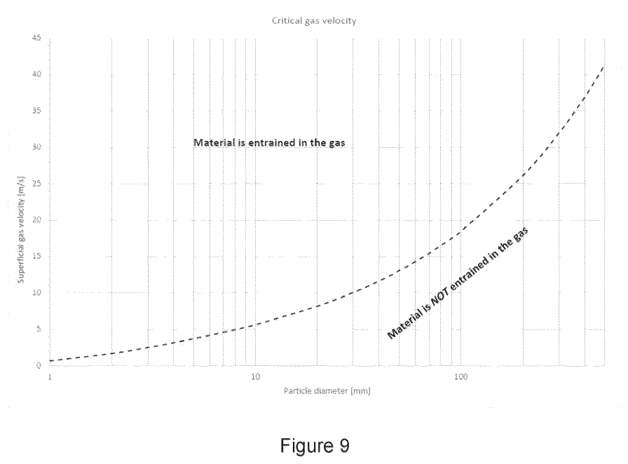

For instance, FIG. 9 shows the theoretical relationship of the critical gas velocity (i.e. the gas velocity, at which the particles are entrained in the gas) as a function of the particle diameter for spherical clay particles between 1 mm and 500 mm and the superficial gas velocity. The superficial gas velocity is the theoretical gas velocity in the tube, if no particles were present. If the superficial gas velocity at a given particle diameter is higher than the critical gas velocity, the particles are carried with the gas, and if the gas velocity is lower, the material is not carried with the gas.

The term “particles are not entrained in the gas” means that at least 95 vol. %, preferably at least 97.5 vol. %, more preferably at least 99 vol. % of the particles are not entrained in the gas. In other words, the present invention encompasses the case, where the bed of nodules may contain minor amounts of particles that are entrained in the gas. These minor amounts of particles constitute for instance powder particles with a particle size of smaller than 1 mm that are present in the raw material that is fed in the system and/or powder particles with a particle size of smaller than 1 mm that are generated in the bed by abrasion due to a movement of the particles.

The method in accordance with the present invention ensures that the calcining can be conducted very energy efficient. This can be explained by the fact that a very efficient heat transfer from the gas to the nodules can be achieved, when the gas passes through the bed of nodules in a way that the nodules do not become entrained in the gas.

In particular, the inventive method is more energy efficient, when compared to a method, which involves such an entrainment. An entrainment particularly occurs in conventional methods, wherein the raw material of the supplementary cementitious material is used in a powder form. Powder materials are easily entrained in a passing gas, even at a relatively low gas flow rate, due to their small particle size and particle mass. The reason for the fact that the inventive method is more energy efficient can be explained as follows: The calcination process of a given raw material particle consumes a certain amount of thermal energy, which is transferred from the gas to the particle. The calcination of the particle starts at the particle surface upon contact with the gas and proceeds further into the particle core. The amount of thermal energy, which is theoretically necessary to calcine a given particle, linearly correlates with the particle mass. However, in case of an entrainment, the contact time between a given gas volume and a distinct fraction of the raw material is relatively long. In turn, the thermal energy, which can be transferred from this gas volume to the distinct fraction of the raw material, which is entrained in this gas volume, may be too low to fully calcine the raw material in said gas volume within the process time. Thus, an entrainment makes it necessary to set the thermal energy of the gas (i.e. its temperature) to a rather high level in order to ensure a full calcination. In practice, conventional methods, where an entrainment takes place, thus require an input of an excess of thermal energy, which cannot be fully used or consumed by the calcining process. In turn, these conventional methods are inferior from an energetic point of view.

Further, the inventive method is more energy efficient, when compared to processes, which involve a calcining of granular raw material in a conventional rotary kiln. The raw material in a rotary kiln is conveyed and rotated, while hot gas passes over the top surface of the raw material bed. In other words, a calcining in a rotary kiln does not include a process set up, where the gas passes through the raw material bed. In turn, the energy transfer is less efficient in case of a rotary kiln, when compared to the inventive method, where that gas passes through the raw material bed. In turn, the temperature of the gas can be set lower in the inventive method, which leads to a more energy efficient process.

The adjustment of the gas temperature, i.e. the maximum calcining temperature, to the claimed range is also associated with further advantages. In particular, the inventive method avoids the occurrence of unwanted discoloration (for instance a reddening or darkening) during the calcining of the supplementary cementitious material or at least reduces such an unwanted discoloration to an acceptable extent. Thus, the resulting cement shows a very bright cement color and no unwanted color change. In turn, the method allows the production of a cement, which has a color that is comparable or similar to a cement produced by exclusively employing Portland type cement. This can be explained by the fact that the calcining temperature of the inventive method can be set lower, when compared to conventional methods. This avoids or at least reduces an unwanted overburning of the raw material, which would be associated with a discoloration. Moreover, the inventive method ensures that the mechanical properties of the resulting cement are advantageous. For instance, the resulting cement has still sufficient mechanical properties, such as compressive strength, which is comparable to Portland cement.

The calcining of the raw material in accordance with the claimed method further achieves a sufficient dehydroxylation and thus lead to a high pozzolanic activity of the resulting supplementary cementitious material. Here, is it important that the raw material of the supplementary cementitious material is calcined at a relatively low temperature, since the temperature of the gas is set to a range of 400 to 800° C. A calcining at such a low temperature avoids a vitrification of the material. In view of this, the mechanical properties of resulting cement, such as the compressive strength, are favorable. In contrast thereto, particles of a supplementary cementitious material, which are calcined at a higher temperature, show a decreased pozzolanic activity, since they cannot undergo a chemical pozzolanic reaction in the cement and become inert.

The resulting high pozzolanic activity ensures that the cement shows favorable mechanical properties, such as compressive strength, that particularly are higher than that of conventional substituted (or blended) cements and that are in embodiments at least comparable to an unsubstituted Portland cement. For instance, the cement may have a compressive strength of 1 to 30 MPa, preferably 5 to 25 MPa, more preferably 10 to 20 MPa after 1 day, and/or 10 to 70 MPa, preferably 15 to 60 MPa, more preferably 20 to 50 MPa after 7 days. In embodiments, the cement shows at least 50%, preferably at least 65%, more preferably at least 80% of the compressive strength of a respective unsubstituted Portland cement. In embodiments, the compressive strength of the final cement product is 50-150%, preferably 75-100%, of that of ordinary Portland cement after 28-days of curing. The compressive strength is measured according to EN 196-1:2000.

Overall, the claimed method optimizes the supplementary cementitious material and ensures that the supplementary cementitious material can be produced in an economic and easy way. Further, the supplementary cementitious material as produced by the claimed method allows the production of cement which avoids discoloration and which leads to a cement having advantageous mechanical properties, such as compressive strength.

In a preferred embodiment, the temperature of the gas is in the range of 400 to 600° C.; preferably in the range of 500 to 600° C., when the device is used for heat-treating solid material with more than 40 weight percent clay minerals pertaining to kaolin group; and/or in the range of in the range of 500 to 775° C., preferably in the range of 550 to 725° C., when the device is used for heat-treating solid material with more than 40 weight percent clay minerals pertaining to smectite group; and/or in the range of 600 to 800° C., preferably in the range of 700 to 800° C., when the device is used for heat-treating solid material with more than 40 weight percent clay minerals pertaining to illite group. In particularly preferred embodiments, the content of these clay minerals in the supplementary cementitious material is 50 wt % or more, preferably 65 wt % or more, more preferably 80 wt % or more. These temperature and content ranges ensure a particularly efficient process set up.

The arrangement of the bed of nodules is not restricted as far as it allows that the calcining is conducted by passing gas through a bed of nodules, without the nodules becoming entrained in the gas. However, it is preferred that the bed of nodules is arranged in a vertical configuration and moves downwards due to gravity during the calcining step. Such an arrangement particularly ensures that the inventive method can be conducted very cost efficient and on a large scale.

According to a further preferred embodiment, the movement of the bed of nodules is an isokinetic movement, wherein the nodules, in a cross-sectional view perpendicular to the movement direction, have the same displacement within a time period. This allows a particularly equal and efficient calcining of the nodules.

In case of a movement of the bed of nodules, it is also preferred that the gas passes the bed of nodules in a direction that is opposite to the movement direction of the bed of nodules. According to another embodiment, the inventive method encompasses the case that the movement direction of the gas is transversal to the movement direction of the bed of nodules. This allows a particularly efficient calcining of the nodules.

In case of a movement of the bed of nodules, it is particularly preferred that the ratio of gas to nodules is in the range of 0.5:1.0 to 4.0:1.0 kg gas/kg nodules, preferably 1.0:1.0 to 3.0:1.0 kg gas/kg nodules. The speed of the nodules is determined by weighing the nodules at the extraction point. The gas flow is determined in the exhaust gas with a pitot tube measurement or the like measurement device.

The calcining retention time of the raw material of the supplementary cementitious material at the calcining temperature may be selected, depending on the particle size of the raw material of the supplementary cementitious material. The retention time for particle sizes below 20 mm is 1 to 300 minutes, preferably 3 to 200 minutes, more preferably 5 to 120 minutes, most preferably 10 to 90 minutes. The retention time for particle sizes above 20 mm is 5 to 500 minutes, preferably 7 to 300 minutes, more preferably 10 to 200 minutes, most preferably 15 to 90 minutes. This ensures a particularly effective production process.

The inventive method may further comprise the following optional process steps:

In embodiments, the claimed method further may comprise the step of crushing and/or sieving the raw material of the supplementary cementitious material prior to the nodularizing step. This particularly ensures that the subsequent nodularizing step can be conducted in an optimized manner, since the crushing ensures the provision of a raw material with an optimized particle size. Crushing may particularly not be necessary for raw materials having small particle sizes, such as marine clays.

The crushing processes and devices are not limited and are known to a person skilled in the art. Preferably, the step of crushing the raw material of the supplementary cementitious material is conducted by a device selected from the group comprising a roller press, a jaw crusher, a hammer rusher, a cone crusher, or a combination thereof. The average particle size of the crushed material is preferably 10 μm to 50 mm, more preferably 0.1 mm to 20 mm. Sieving processes and devices are also not limited and are known to a person skilled in the art. This ensures a particularly optimized process set-up. The crushing and/or sieving may also be accompanied with a drying of the raw material of the supplementary cementitious material prior to the calcining step. Such a drying step particularly ensures that the raw material of the supplementary cementitious material can be conveniently converted to the final supplementary cementitious material in an economic way.

Further, it is preferred that the method comprises the step of milling the calcined nodules. In embodiments, the particle size of the final supplementary cementitious material is 1 to 100 μm, preferably 10 to 90 μm, more preferably 20 to 80 μm. The supplementary cementitious material has in embodiments a surface area using the Blaine method described in EN 196 of 100 to 3000 m²/kg, preferably 500 to 2000 m²/kg, more preferably 700 to 1500 m²/kg, in particular 300 to 1500 m²/kg. The determination of the surface area is performed using the Blaine method described in EN 196-6:1989. The subsequent milling of the calcined raw material of the supplementary cementitious material particularly ensures that the resulting supplementary cementitious material has an average particle size that allows an improved pozzolanic activity. Further, it can be ensured that the resulting cement shows a very bright cement color and no unwanted color change.

Alternatively or additionally, the method may further comprise a cooling step of after the calcining step and before the optional milling step. The cooling is not limited and may be preferably conducted with a direct solid/gas contact heat exchanger of the counter flow type like a planetary cooler, rotary dryer/rotary heat exchanger or a shaft kiln type heat exchanger. Otherwise of the cross-flow type including walking floor cement coolers or like disclosed in EP20174299.6. The cooling conditions are not limited and may be for instance 200° C./min or less, preferably 150° C./min or less, more preferably 100° C./min or less. Such a cooling step leads to a particularly economical process set-up.

In further embodiments, the method may comprise a heat recuperation step after the calcination step and before the milling step as disclosed in EP20174299.6. The energy derived from the heat recuperation step may be used in any of the drying or preheating or calcining steps and thus enables a particularly favorable process set-up from an economic point of view.

In embodiments, the inventive method also comprises a step of heat-treating the supplementary cementitious material by calcining a raw material of the supplementary cementitious material with a device that comprises a kiln, wherein the supplementary cementitious material is led through the kiln on at least one grate plate and a hot gas at a gas temperature is led through said supplementary cementitious material inside the kiln. Such a method particularly enables that the gas passes through a bed of a raw material of the supplementary cementitious material, which is present on the grade plate, in a way that the bed of the raw material of the supplementary cementitious material is not entrained in the gas.

### Suitable Devices

Suitable devices for calcining the nodules in accordance with the inventive method as defined above are not limited as far as they ensure that the calcining is conducted by passing gas, having a temperature in the range of 400 to 800° C., through a bed of nodules, without the nodules becoming entrained in the gas. In the following, a preferred embodiment of a particularly suitable device will be described in more detail. However, the present invention is not restricted to such an embodiment.

Preferably, the device is a device for heat-treating solid material, in particular in granular form, wherein the device comprises a kiln and an external heat source, wherein said device comprises at least two, preferably more than two, steps arranged above each other, wherein each step comprises a gas permeable sloped sliding surface on which a bed of said solid material slides down within said device due to gravity and wherein said sloped sliding surfaces of said steps directly consecutive to each other slope in opposite directions, wherein the kiln comprises at least one, preferably at least two, of said steps and the kiln is configured such that a hot gas generated by the external heat source is led through said solid material inside the kiln to heat said solid material to a de-sired temperature in order to change the substance properties of said solid material.

The device comprises at least one gas temperature adjustment system comprising a gas outlet in a second step of said steps, a temperature adjustment zone and a gas inlet in a first step of said steps, preferably the first step being arranged directly consecutive and above the second step, wherein at least the first step is one of said at least one step inside the kiln and wherein said gas temperature adjustment system is adapted such that hot gas is extracted from said second step through the gas outlet, directed into a temperature adjustment zone where an hot gas temperature is adjusted to an adjusted temperature by the external heat source and reintroduced into said first step at said adjusted temperature.

One major advantage of such a specific device is that the temperature in said first step can be controlled precisely to the desired temperature due to the reintroduction of hot gas at the adjusted temperature. Thus, it can be ensured that the material does not experience temperatures above the allowed maximum temperature. Furthermore, the material is not exposed to radiation from an internal burner. Further, the temperature adjustment by the gas temperature adjustment system only requires a small new energy input by the external heat source, as the temperature of the hot gas extracted from said second step is close to the desired kiln temperature.

Different heat sources may be used as external heat source. For example, the heat source may be a separate combustion unit and/or a heat exchanger and/or any other suitable heat generating device. For example, the heat source may be a device selected from the group comprising a combustion unit, electrical furnace, a solar power device, a waste heat device, a heat storage unit, a plasma burner or a combination thereof.

Preferably, the heat transfer is achieved in a cross-flow configuration, wherein the solid material moves downwards and the hot gas upwards inside the kiln. This offers the advantage that the heat transfer from the hot gas to the solid material is repeatable, can easily be controlled, and is highly efficient. It further adds to a homogenous heat treatment of the solid material.

Preferably, the sloping angle of the sloped sliding surface to the horizontal is preferably in the range of from 10° to 55°, and more preferably from 20° to 45°.

Also preferably, said sloped sliding surface is adapted to allow an isokinetic motion of said solid material along said sloped sliding surface. An isokinetic motion is achieved, when all particles in a cross-sectional view perpendicular to the transport direction, will have the same displacement within a specific time period. The main advantage of this feature is that the heat transfer is efficient, repeatable and easy to control. An isokinetic motion of the solid material is achieved if no vertical mixing of the layers of the bed of solid material occurs. Ideally, the relative position of each piece of material remains the same with regard to the neighboring piece of material while the bed of solid material slides down along the sliding surface.

The expression “solid material slides down within the kiln due to gravity” in accordance with the present invention means that the kiln is configured such that the material automatically slides down along the sloped sliding surfaces merely due to gravity and without the need of any pusher or moving means of the kiln. Consequently, the kiln preferably does not comprise any moving parts that come into contact with said solid material. This adds to a simple construction and leads to low maintenance efforts.

According to a preferred embodiment, the device further comprises a cooler section, wherein the kiln is arranged above the cooler section and wherein the cooler section comprises at least one, preferably at least two, of said steps, wherein the device comprises one of said gas temperature adjustment systems of which the second step is formed by an uppermost step of the at least one step inside the cooler section and the first step is formed by a lowermost step of the at least one step inside the kiln. Preferably, the kiln comprises at least two steps, wherein each step of the kiln is connected to the step below by means of one of said gas temperature adjustment systems. This allows the temperature to be set precisely at each step of the kiln, and this is done in a very energy-efficient manner. Since the temperature can be precisely controlled in the entire kiln, a very efficient calcination can be carried out and the process can be carried out in a very small and precise temperature window, which in turn allows a further increase in energy efficiency and optimal final SCM properties.

According to a further embodiment, said gas temperature adjustment system is adapted such that at least 50%, preferably at least 70%, more preferably at least 90%, of the hot gas that leaves said second step leaves said second step through the gas outlet. Preferably, said gas temperature adjustment system is adapted such that said adjusted temperature of the hot gas is such that said solid material in the first step is heated to said desired temperature. Due to a significant portion of the hot gas passing from the second step to the first step through the gas temperature adjustment system, the temperature in the first step can be adjusted very precisely to the desired temperature by the hot gas at the adjusted temperature entering the first step. The adjusted temperature, that said gas temperature adjustment system is adapted to heat the gas, depends on the proportion of the gas that is passed through the gas temperature adjustment system. If only a smaller portion, for example slightly above 50%, is passed through the gas temperature adjustment system, the adjusted temperature may be above the desired temperature in order to achieve the desired temperature in the first step in combination with the hot gas reaching the first step via the inside of the kiln. At higher portions, the adjusted temperature will be closer to or identical with the desired temperature.

The device has the advantage that the calcining of the SCM raw material is very efficient. Thus, the calcining temperature of the raw material of the supplementary cementitious material can be particularly set to a relatively low range, when the calcining step is conducted with a device according to this embodiment. In particular, the device ensures that the gas temperature can be set to the range of 400 to 800° C., which constitutes the maximum calcining temperature. This has the advantage that the method can be performed very cost-efficient. Further, an overheating of the raw material can be particularly avoided, which leads to even more improved color properties of the resulting cement.

According to a preferred embodiment, the device comprises a control unit that is adapted to control the adjusted temperature to a set point in the range of 400 to 600° C.; preferably in the range of 500 to 600° C., when the device is used for heat-treating solid material with more than 40 weight percent clay minerals pertaining to kaolin group; and/or to a set point in the range of in the range of 500 to 775° C., preferably in the range of 550 to 725° C., when the device is used for heat-treating solid material with more than 40 weight percent clay minerals pertaining to smectite group; and/or to a set point in the range of in the range of 600 to 800° C., preferably in the range of 700 to 800° C., when the device is used for heat-treating solid material with more than 40 weight percent clay minerals pertaining to illite group. This adjusted temperature corresponds to the gas temperature in the device and thus constitutes the maximum calcining temperature.

Preferably, the control unit is connected to at least one thermocouple at the gas inlet of the at least one gas temperature adjustment system to control the hot gas temperature to the adjusted temperature. The high energy efficiency of the device makes it possible to use hot gas at significantly lower temperature values than in previously known systems and still achieve satisfactory heat treatment of the above-mentioned solid materials. This results in a large energy saving potential.

In a further preferred embodiment, said control unit is adapted to control the adjusted temperature to stay inside a temperature range of +/−40° C., preferably of +/−20° C., around said set point. This allows the material to be heat treated even better with the device.

In an another embodiment, a compartment is arranged below said sloped sliding surface, which is part of said first step comprising said sliding surface above and to which said gas inlet of said gas temperature adjustment system is connected, wherein the device is adapted such that said hot gas, which is extracted via said gas outlet of the gas temperature adjustment system from the second step and which temperature is adjusted in the temperature adjustment zone of the gas temperature adjustment system, is introduced into said compartment of said first step and then passes through openings in said sloped sliding surface of said first step. As a result, the hot gas at the adjusted temperature can be introduced constructively easy into the first step in such a way that it can be evenly led into the solid material located in the first step. Preferably, said gas inlet is formed as an aperture in the wall of the kiln inside the compartment or as a tube with several apertures arranged on the outer surface of the tube, which projects into the compartment or which is arranged next to the compartment, such that the apertures are directed into the compartment.

In a particularly preferred embodiment, said compartment comprises compartment walls that are dust permeable or that are sealed, wherein the compartment preferably comprises a dust extraction mechanism in case said compartment walls are sealed, wherein especially preferably said extraction mechanism comprises an extraction auger placed at a locally low situated point of the compartment. In case dust permeable compartment walls are used, dust that may have passed through the openings in the sloped sliding surface cannot accumulate in the compartment, but is passed on to the step below. This is not the case for sealed compartment walls, which have the advantage that no hot gas can enter the compartment from below. Hence, preferably for sealed compartment walls a dust extraction mechanism is arranged inside the compartment. Further, for sealed compartment walls, preferably, a bottom wall of the compartment is arranged at a slope to an outer wall of the kiln so that dust can slide down the bottom wall and be removed at a lowest point by the dust extraction mechanism.

In another preferred embodiment, the device comprises a kiln and an external heat source, wherein said kiln comprises at least two steps arranged above each other, wherein each step comprises a gas permeable sloped sliding surface on which a bed of said solid material slides down within said kiln due to gravity while a hot gas generated by the external heat source is led through said solid material to heat said solid material to a desired temperature in order to change the substance properties of said solid material and wherein said sloped sliding surfaces of said steps directly consecutive to each other slope in opposite directions, a solution of the object according to the invention exists if said sloped sliding surface comprises a plurality of gas permeable grate plates through which said hot gas passes, wherein said grate plates are suspended at their upper end from a support and their lower ends only rest on a further support or on the upper end of a further grate plate which is suspended from said further support. This allows a very simple and cost-effective construction of the sloped sliding surfaces, which at the same time allows the structure to react flexibly to the different expansion level of the grate plates due to temperature changes, for example, when the temperature is raised after the kiln has been switched off. The alternative solution at the same time constitutes a preferred embodiment of device.

In a particularly preferred embodiment, said grate plates overlap in a direction along the sloped sliding surface and preferably also in a horizontal direction, wherein preferably said grate plates are only suspended from said support on one edge of the upper end. This additionally simplifies the construction of the sloped sliding surfaces and ensures a continuous sliding surface regardless of the temperature currently present in the kiln.

According to another preferred embodiment, said support comprises a pipe with an insulation and fins on which said grate plates are suspended from. This provides a constructively simple and robust design of the supports. The insulation improves the mechanical strength of the pipe and also minimizes the temperature fluctuations and thus the expansion and contraction of the pipes. Preferably, said pipe comprises an air inlet and an air outlet. Through these air inlet and outlet, active or passive regulation of the temperature of the pipes can be achieved, so that their mechanical strength can be further improved and they experience even smaller temperature fluctuations.

Yet according to another preferred embodiment, vertical plates are suspended at the lowest support of said sloped sliding surface to form a channel in interaction with a wall of the kiln. This allows the passing of solid material from one of the steps to the step below to be controlled in a structurally simple manner.

According to another preferred embodiment, the device comprises two kilns, a first kiln and a second kiln, which are arranged adjacent to each other sharing a common wall, and wherein the device comprises at least two gas temperature adjustment systems, where-in the first step of a first of the at least two gas temperature adjustment systems is one of said at least one step inside the first kiln and wherein the first step of the second of the at least two gas temperature adjustment systems is one of said at least one step inside the second kiln. This allows the height of the device to be reduced while maintaining the same possible material throughput and heat treatment.

In a further preferred embodiment, said first kiln and said second kiln comprise the same number of steps, wherein the sloped sliding surface of the at least one step inside the first kiln and the sloped sliding surface of the at least one step inside the second kiln is symmetrically arranged to said common wall, wherein sloping directions of the sloped sliding surfaces of the steps in the first kiln and the second kiln are not parallel to a plain of said common wall. This enables a particularly simple and compact design of the two kilns.

In a particularly preferred embodiment, the at least one step inside the first kiln and the at least one step inside the second kiln of which an upper edge of the sloped sliding surface is arranged at said common wall comprise a compartment aa defined above, wherein preferably said common wall comprises an opening between said compartments of the at least one step inside the first kiln and the at least one step inside the second kiln of which an upper edge of the sloped sliding surface is arranged at said common wall to form a common compartment.

A device according to this embodiment is particularly advantageous, since it can be used for a method for producing a supplementary cementitious material in accordance with the claimed invention and particularly ensures the favorable effects as did above. In particular, a calcining of the SCM raw material in a device according to this embodiment ensures that the supplementary cementitious material can be produced in a high and consistent quality, with low production costs and on a large-scale. Moreover, the resulting supplementary cementitious material can be used in the production of a cement with improved color properties and mechanical properties, such as compressive strength. Further, the a calcining of the SCM raw material in a device according to this embodiment achieves that the SCM raw material is calcined at a temperature that is lower than the calcining temperature of commonly known devices. However, the calcining of the raw material at this low temperature is still associated with a sufficient dehydroxylation and a high pozzolanic activity of the resulting supplementary cementitious material.

Distinct embodiments of this device are specified in the following:

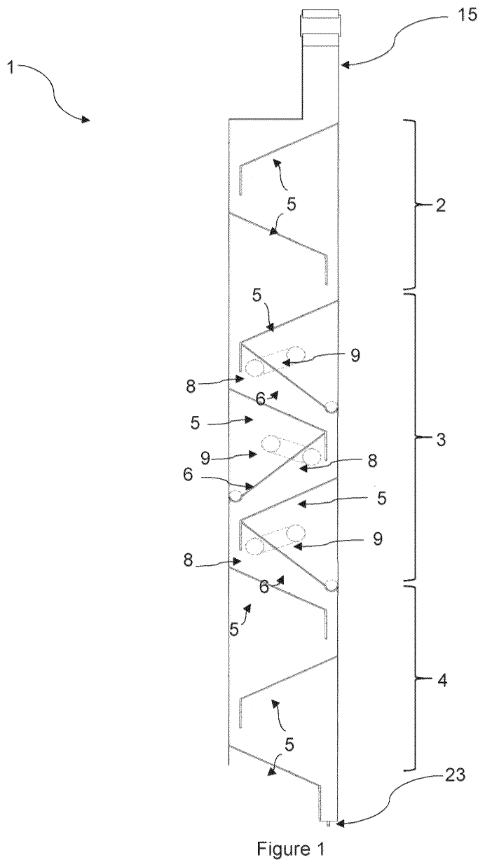

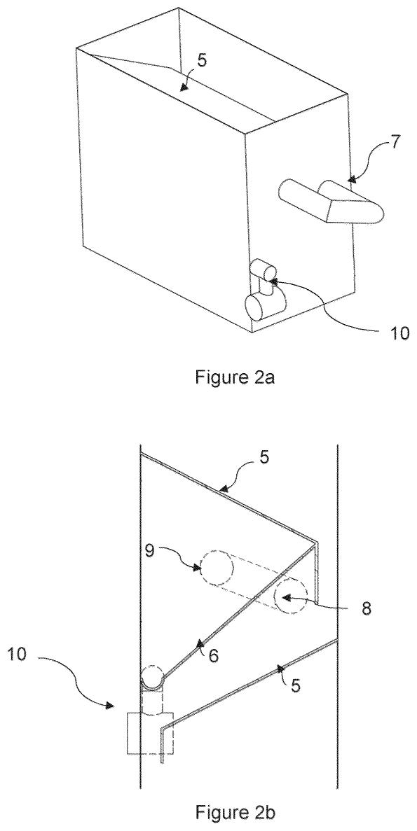

A first embodiment of a device 1 is illustrated in FIGS. 1 and 2. FIG. 1 shows a longitudinal section of the first embodiment of the device 1, FIGS. 2a and b show a perspective view and a longitudinal section of a first and second step of the kiln of the first embodiment.

The device is configured as a vertical tower with a feeding device 1 at its top end for feeding solid granular material into the device. The solid granular material, experiences a heat treatment when passing through the device such that the material is calcined. The finished product is discharged from the device at a lower end of the tower via a suitable discharging device 23, which discharges the solid granular material at a certain controllable rate. The device 1 shown in FIG. 1 comprises an upper preheater 2, a kiln 3 in the middle, and a cooler section 4 forming a lower portion of the tower. The solid granular material is first preheated in the preheater 2, then passes on to the kiln 3 in which the calcination takes place, and is subsequently cooled down in the cooler 4 to an acceptable outlet temperature.

A plurality of opposite gas permeable sloped sliding surfaces 5 are arranged within the tower such that the solid granular material can slide down through preheater 2, kiln 3 and cooler section 4 in cascade from one sloped sliding surface 5 to another. In the exemplary embodiment, the preheater 2 comprises two sloped sliding surfaces 5 wherein the cooler section 4 and the kiln 3 comprise three sloped sliding surfaces 5 each. Each sloped sliding surface 5 represents one step of preheater 2, kiln 3 and cooler 4. As shown in FIG. 1, the kiln 3 comprises three steps, wherein the kiln steps also include a compartment below, which is formed by a compartment wall 6 and the kiln walls.

To keep the temperature at the desired temperature or within the desired temperature range inside the kiln 3, the device comprises gas temperature adjustment systems 7. An embodiment of such a system 7 is shown in FIGS. 2a and b, which show a perspective view and a longitudinal section of a section of the device 1 with a first and a second step, a gas temperature adjustment system 7 and a dust extraction device 10. The upper first step is the lowest step inside the kiln 3 and the lower second step is the uppermost step inside the cooler section 4. The gas temperature adjustment system 7 comprises a gas outlet 8, which is arranged in an area above the sloped sliding surface 5 of the second step that is considered part of the second step. The gas outlet 8 leads to a temperature adjustment zone, in which the temperature of the hot gas that is extracted from the second step via the gas outlet 8 is adjusted by an external heat source. The external heat source is not shown in the figures. Further, the gas temperature adjustment system 7 comprises a gas inlet 9 that leads into the compartment of the first step, which is arranged directly above the second step. The hot gas, which temperature was adjusted inside the temperature adjustment zone 7, is introduced into the first step via the gas inlet 9 to be introduced into the solid granular material inside the first step via gas openings in the sloped sliding surface 5 of the first step. Thereby the adjusted temperature, to which the external heat source heats the hot gas in the temperature adjustment zone, depends on the portion of hot gas that is extracted via the gas outlet 8 in comparison to the hot gas that travels from the second step to the first step inside the kiln 3. These gas temperature adjustment systems 7 connect the steps of the kiln 3 and the uppermost step of the cooler section 4 with the lowest step of the kiln in the first embodiment shown in FIGS. 1, 2a and b.

Next to the gas temperature adjustment system 7, FIG. 2a and b also show the dust extraction device 10. The compartment of the first step is sealed towards the underside by a sealed compartment wall 6. Hence, dust that enters the compartment through the gas openings in the sloped sliding surface 5 cannot leave the compartment through the bottom compartment wall 5. To prevent dust from accumulating in the compartment, the bottom compartment wall 5 is slanted so that the dust slides down into a corner. This is where the dust extraction device 10 is located, which in this embodiment consists of an extraction auger.

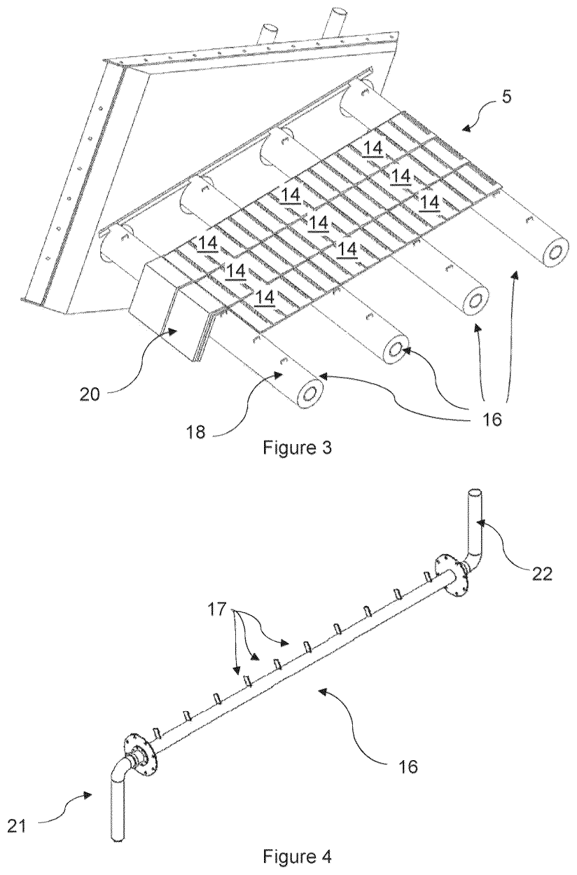

FIG. 3 shows a perspective view of a partly assembled sloped sliding surface 5, as used in the above-described embodiments for the sloped sliding surfaces 5 of at least the kiln 3. The sloped sliding surface 5 thereby comprises a plurality of gas permeable grate plates 14. The grate plates 14 are suspended at their upper end from a support tube 16. For the suspension, the support tubes 16 comprise fins 17 that pierce an insulation 18 of the support tubes 16. The grate plates 14 comprises a mounting point 19 at one edge on their upper end, which can be attached to the fins 17. The lower end of an upper grate plate 14 is arranged on the upper end of a lower grate plate 14, which in turn is suspend at its upper end by another support tube 16. The lower end of the lowest row of grate plates 14 of a sloped sliding surface 5 is arranged on another component, which is suspend on the lowest support tube 16 and which comprises a vertical plate 20 that forms a channel in interaction with a wall of the kiln 3. This arrangement allows the individual grate plates 14 to move relative to each other due to temperature fluctuations without creating pressure on the outer walls of the kiln 3 and still ensuring a continuous surface of the sloped sliding surface 5. Besides, the vertical plate 20 allows a controlled transition of the solid material from one step to the next below.

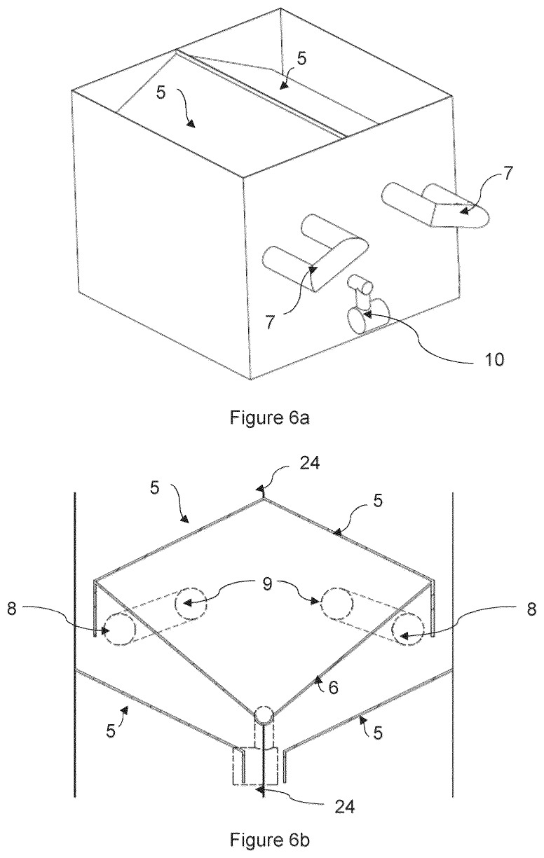

FIG. 4 shows the support tubes without insulation 18. Since the support tubes 16 are fixed to the outer walls of the kiln 3, expansion due to temperature fluctuations in the kiln 3 should be avoided. For this reason and for improved mechanical stability, the support tubes 16 comprise, on the one hand, the insulation 18 and, on the other hand, as shown in particular in FIG. 6, comprise an air inlet 22 and an air outlet 23. Natural or forced convection can take place through these, so that the expansion of the support tubes 16 can be kept small.

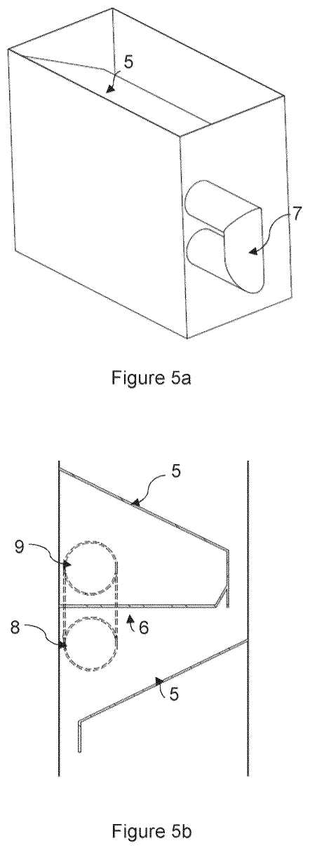

FIG. 5a and b show a perspective view and a longitudinal section of a first and second step of a device 1 according to a second embodiment of the present invention. The device 1 comprises a gas temperature adjustment system 7 and is advantageous due to its simplicity, as the compartment below the respective sloped sliding surface 5 is constructed with a sealed horizontal compartment wall 6 and without a dust extraction device 10. Further, the gas outlet 8 of gas temperature adjustment systems 7 in the second step and the gas inlet 9 of the gas temperature adjustment systems 7 to the compartment of the first step are arranged vertically to each other, which also facilitates the construction and allows a very compact gas temperature adjustment system 7.

FIGS. 6a and b show a perspective view and a longitudinal section of a first and second step of a first gas temperature adjustment system 7 and a first and second step of a second gas temperature adjustment system 7 of a fourth embodiment of the device 1 that comprises two parallel arranged kilns 3 that share a common wall 24. The sloped sliding surfaces 5 in the respective kilns 3 are arranged symmetrically to a plain of the common wall 24. Further, the first steps inside the respective kiln share a common compartment, in which the common wall 24 is interrupted and into which the gas inlets 9 of the first and second gas temperature adjustment system 7 shown in FIGS. 6a and b lead into. This common compartment is also equipped with a common dust extraction device 10.

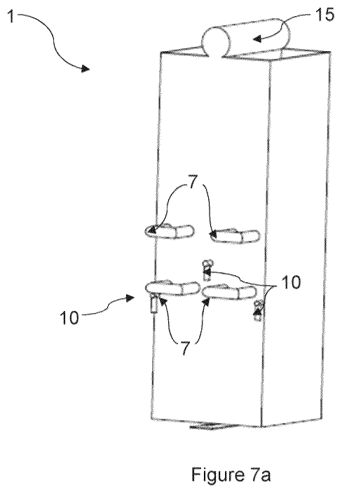

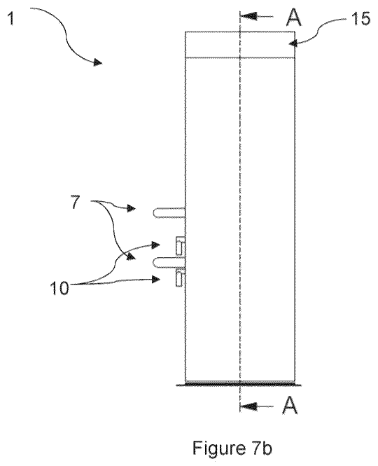

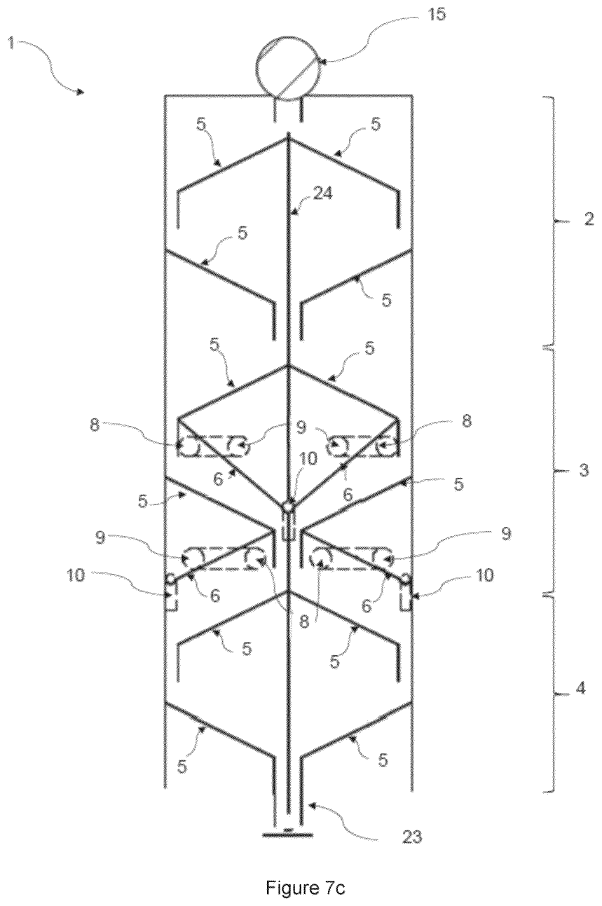

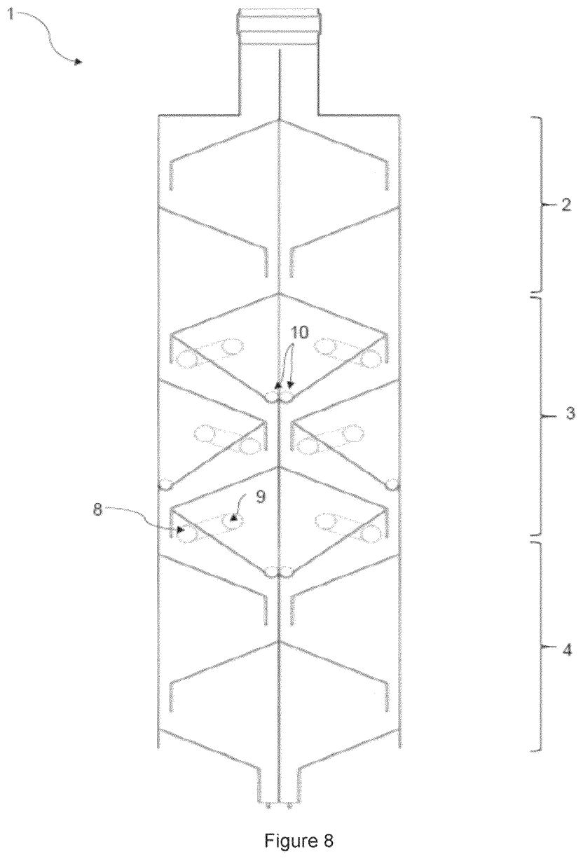

FIGS. 7a, b and c show another embodiment of the device 1, wherein FIG. 7a shows a perspective view of this embodiment of the device 1, FIG. 7b shows a side view of the embodiment of the device 1 and FIG. 7c shows a longitudinal section A of the embodiment of the device that is indicated in FIG. 7b. The device 1 according to this embodiment comprises two parallel arranged preheaters 2, kilns 3 and cooler sections 4 that share a common wall 24, wherein the preheaters 2, kilns 3 and cooler sections 4 all comprise two steps and wherein the sloped sliding surfaces 5 in the respective preheaters 2, kilns 3 and cooler sections 4 are arranged symmetrically to the common wall 24. The steps inside the kiln 3 each comprise a compartment below the respective sloped sliding surface 5 and are connected via a gas temperature adjustment system 7 to the step directly below. The compartments that are arranged adjacent to the common wall 24 comprise a common dust extraction device 10. The compartments that are arranged on walls facing the common wall 24 comprise separate dust extraction devices 10. In this embodiment, the two parallel preheaters 2 are fed by one feeding device 15 and the two parallel cooler section 4 lead into one extraction device 23.

FIG. 8 shows a further embodiment of the device 1, which is similar to the embodiment shown in FIGS. 7a, b and c. The differences are that the two parallel arranged kilns 3 and cooler sections 4 have three steps each instead of two. Further, the compartments of the steps inside the kilns 3, which are arranged at the common wall 24, comprise separate dust extraction devices 10. Lastly, the gas inlet 9 of the gas temperature adjustment systems 7 is arranged slightly above the gas outlet 8 of the gas temperature adjustment systems 7 and not at the same height as for the embodiment of the device 1 shown in FIGS. 7a, b and c.

Other embodiments with two parallel kilns 3 are also possible. For example, the device 1 can also comprise only a single preheater 15 and/or only a single cooler section 4, or the parallel preheaters 2 are fed by two feeding devices 15 and the parallel cooler sections 4 lead into two extraction devices 23.

The calcining of a SCM raw material can be conducted with a device according to these embodiments.

### Method for Producing Cement

The present invention concerns a method for producing a cement comprising a milled cement clinker and a supplementary cementitious material. The supplementary cementitious material is produced by the method as defined above. The milled cement clinker is produced by a clinkerization process comprising the steps of calcining and subsequently milling limestone-based raw material. The advantageous effects of the method for producing a cement are specified above in connection with the methods for producing a supplementary cementitious material.

The method for producing the milled cement clinker is not limited. Any clinkerization processes that are known in the art can be applied. The milling of the cement clinker may be conducted separately or together with the milling of the supplementary cementitious material. In particular, the methods for producing a cement comprising a supplementary cementitious material as disclosed in PCT/EP2020/081722 may be applied, which are herewith incorporated by reference.

The method for producing a cement comprising a supplementary cementitious material in accordance with the present invention allows that the step of calcining of the raw material of the supplementary cementitious material and the step of calcining of the limestone-based raw material to produce the cement clinker can be conducted separately, i.e. in separate containers. These separate calcining steps allow a flexible process set-up and particularly ensure the possibility of producing a cement with high substitution rates of the cement clinker.

In a preferred embodiment of the method according to the present invention, the milling of the calcined raw material of the supplementary cementitious material and the milling of the calcined cement clinker are conducted together, which means that the milling is conducted simultaneously in the same milling device after mixing the components. This can be conducted due to the fact that the particle sizes of the calcined raw material of the supplementary cementitious material and the cement clinker are in a similar range. Such a simultaneous milling ensures a particularly efficient process set-up, which cannot be achieved by conventional methods that involve a milling of supplementary cementitious materials prior to calcining.

Alternatively, the milling of the calcined raw material of the supplementary cementitious material and the milling of the cement clinker can be conducted separately, followed by mixing the milled components. This allows a high variability of the process set-up.

In embodiments, the content of the supplementary cementitious material in the cement is 1 to 50 wt. %, preferably 5 to 45 wt. %, more preferably 10 to 40 wt. %, most preferably 15 to 35 wt. %, based on the overall content of the cement. Such high substitution rate ensures that the resulting cement is favorable in terms of environmental issues due to its reduced CO₂ emission during the cement production and simultaneously shows a sufficient compressive strength.

A cement that is obtainable by these methods has favorable product properties. In particular, the cement comprises milled cement clinker and a supplementary cementitious material, wherein the supplementary cementitious material comprises an amorphous constituent in more than 30 wt. %. Preferably, the amorphous constituent is present in more than 40 wt. %, more preferably in more than 50 wt. %, most preferably in more than 65 wt. %. The term “amorphous constituent” in terms of the present application is defined as one or more components of the supplementary cementitious material that show an amorphous microstructure, i.e. that do not have any crystallinity. The weight percentage of the amorphous constituent can be measured by XRD through the Rietveld method. Alternatively, solid-state nuclear magnetic resonance (NMR) spectroscopy can be applied to determine the amorphous content. The amorphous constituent actively participates in the pozzolanic reaction. Thus, such a high amount of amorphous constituents in the SCM ensures a superior pozzolanic activity in the cement and results in favorable mechanical properties, such as an improved compressive strength.

The present inventors found that the amount of amorphous constituents in the SCM is strongly affected by the calcining temperature as well as the average particle size and the particle size distribution as discussed above. In particular, it is important during the calcining process that times, where the maximum calcining temperature is above 800° C., are to be avoided. Even very short times result in an overheating or overburning that reduces the amount of active amorphous constituents and increases the formation of inert crystalline components that do not show a sufficient pozzolanic activity.

To achieve the desired properties of the cement, it is further preferable that the supplementary cementitious material comprises less than 70 wt. % of inert components selected from the group comprising mullite, spinel, feldspar, diopside, mica, or combinations thereof. In embodiments, the supplementary cementitious material has less than 50 wt. %, preferably less than 40 wt. %, more preferably less than 30 wt. %, of said inert components. This ensures a favorable pozzolanic activity of the SCM and improved optical and mechanical properties of the resulting cement.

The color of the cement is in the range of 130-160, 130-160, 120-160, and preferably in the range of 130-170, 130-150, 120-150, wherein the measurement of the cement color is conducted by a RGB2 colorimeter. In particular, the measurement of the cement color may be conducted by a handheld RGB2 colorimeter from PCE Instruments™. The measurements are made on hardened concrete prims. Colors are referenced to a RGB scale of 0 to 255, wherein 100% cement has RGB color values in the range of 130-145, 130-145, 125-140.

Overall, the advantages of the cement in accordance with the present invention are that it can be produced with reduced CO₂ emission and energy consumption, shows a high substitution rate of the milled cement clinker, and has a reduced unwanted discoloration and increased mechanical properties, such as compressive strength, when compared to other substituted cements.

### EXAMPLES

The advantageous effects of the present invention are demonstrated by the following examples.

### Measurement Methods

The following analytical measurements were conducted:

Average particle size: The average particle size is the arithmetic average particle size as measured according to ASTM C 430-96 (2003).

Amount of clay minerals in composition: The amount of the clay minerals in the composition was measured by quantitative X-ray diffraction.

Compressive strength: The compressive strength was measured according to EN 196-1:2000 for 1, 3, 7, and 28 days, respectively.

Cement color: Measurement device: Handheld RGB2 colorimeter from PCE Instruments™. The measurement of the cement color was conducted on hardened concrete prims. Colors are referenced to a RGB scale of 0 to 255.

### Example 1

A cement was produced by the following method: Milled Portland cement clinker (i.e. Portland cement “CEM-I 52.5N”) was prepared by milling clinkers in a ball mill to particles having a particle size of 75 μm. Separately, a supplementary cementitious material was prepared by employing SCM1. Then, the milled cement clinker and the supplementary cementitious material SCM1 were blended during compressive strength testing in a ratio of 65 wt. % to 35 wt. % to obtain a cement.

SCM1 is a nodularized supplementary cementitious material (amount of clay minerals: 60 wt. % smectite, 26 wt. % illite; particle size prior to calcination: 10 to 20 mm). The preparation of SCM1 is as follows: The clay raw material was turned into nodules prior to calcination. The calcining process was conducted at 625° C. by employing device 1. The SCM1 nodules were subsequently milled in a ball mill to a particle size of 45 μm. The nodularizing was conducted with an extruder.

### Example 2

A cement was produced by the following method: Milled Portland cement clinker (i.e. Portland cement “CEM-I 52.5N”) was prepared by milling clinkers in a ball mill to particles having a particle size of 75 μm. Separately, a supplementary cementitious material was prepared by employing SCM1. Then, the milled cement clinker and the supplementary cementitious material SCM2 were blended during compressive strength testing in a ratio of 65 wt. % to 35 wt. % to obtain a cement.

SCM2 is a nodularized supplementary cementitious material (amount of clay minerals: 60 wt. % smectite, 26 wt. % illite; particle size prior to calcination: 10 to 20 mm). The preparation of SCM2 is as follows: The clay raw material was turned into nodules prior to calcination. The calcining process was conducted at 675° C. by employing device 1. The SCM2 nodules were subsequently milled in a ball mill to a particle size of 45 μm. The nodularizing was conducted with an extruder.

### Example 3

A cement was produced by the following method: Milled Portland cement clinker (i.e. Portland cement “CEM-I 52.5N”) was prepared by milling clinkers in a ball mill to particles having a particle size of 75 μm. Separately, a supplementary cementitious material was prepared by employing SCM3. Then, the milled cement clinker and the supplementary cementitious material SCM3 were blended during compressive strength testing in a ratio of 65 wt. % to 35 wt. % to obtain a cement.

SCM3 is a nodularized supplementary cementitious material (amount of clay minerals: 60 wt. % smectite, 26 wt. % illite; particle size prior to calcination: 10 to 20 mm). The preparation of SCM3 is as follows: The clay raw material was turned into nodules prior to calcination. The calcining process was conducted at 725° C. by employing device 1. The SCM3 nodules were subsequently milled in a ball mill to a particle size of 45 μm. The nodularizing was conducted with an extruder.

### Example 4

A cement was produced by the following method: Milled Portland cement clinker (i.e. Portland cement “CEM-I 52.5N”) was prepared by milling clinkers in a ball mill to particles having a particle size of 75 μm. Separately, a supplementary cementitious material was prepared by employing SCM4. Then, the milled cement clinker and the supplementary cementitious material SCM4 were blended during compressive strength testing in a ratio of 65 wt. % to 35 wt. % to obtain a cement.

SCM4 is a nodularized supplementary cementitious material (amount of clay minerals: 60 wt. % smectite, 26 wt. % illite; particle size prior to calcination: 10 to 20 mm). The preparation of SCM4 is as follows: The clay raw material was turned into nodules prior to calcination. The calcining process was conducted at 775° C. by employing device 1. The SCM4 nodules were subsequently milled in a ball mill to a particle size of 45 μm. The nodularizing was conducted with an extruder.

### Comparative Example 1

A cement was produced in accordance with Example 1, with the exception that no SCM was employed.

### Comparative Example 2

A cement was produced in accordance with Example 1, with the exception that 35 wt. % SCM5 is employed.

SCM5 is a nodularized supplementary cementitious material (amount of clay minerals: 60 wt. % smectite, 26 wt. % illite; particle size prior to calcination: 10 to 20 mm). The preparation of SCM5is as follows: The clay raw material was turned into nodules prior to calcination. The calcining process was conducted at 825° C. in a rotary kiln with external combustion at a heating rate of 100° C. with a retention time of 25 minutes. The SCM5 nodules were subsequently milled in a ball mill to a particle size of 45 μm. The nodularizing was conducted with an extruder.

### Comparative Example 3

A cement was produced in accordance with Example 1, with the exception that 35 wt. % LECA particles are employed.

LECA particles (amount of clay minerals: 60 wt. % smectite, 26 wt. % illite; particle size prior to heat treatment: 10 to 20 mm) are produced as follows: The clay raw material was turned into nodules with a particle size ranging between 10 and 20 mm prior to calcination. The calcining process was conducted at 1150° C. in a rotary kiln with external combustion at a heating rate of 100° C. with a retention time of 45 minutes. The nodules were subsequently milled in a ball mill to a particle size below 45 μm. The nodularizing was conducted with an extruder.

### Compressive Strength (CS) Results

TABLE 1

| | | | Calcination | Amount | CS after | CS after | CS after | CS after |
|---|---|---|---|---|---|---|---|---|
| | SCM | Ratio | temperature | of clay | 1 day | 3 days | 7 days | 28 days |
| Ex. | type | [wt. %] | (° C.) | minerals | [MPa] | [MPa] | [MPa] | [MPa] |
| Ex. 1 | SCM1 | 65:35 | 625 | 60 wt. % | 13.2 | 24.3 | 34.6 | 51.4 |
| | | | | smectite, 26 | | | | |
| | | | | wt. % illite | | | | |
| Ex. 2 | SCM2 | 65:35 | 675 | 60 wt. % | 17.2 | 29.3 | 44.8 | 57.3 |
| | | | | smectite, 26 | | | | |
| | | | | wt. % illite | | | | |
| Ex. 3 | SCM3 | 65:35 | 725 | 60 wt. % | 15.2 | 27.7 | 35.3 | 53.9 |
| | | | | smectite, 26 | | | | |
| | | | | wt. % illite | | | | |
| Ex. 4 | SCM4 | 65:35 | 775 | 60 wt. % | 13.4 | 23.2 | 31.3 | 48.1 |
| | | | | smectite, 26 | | | | |
| | | | | wt. % illite | | | | |
| Comp. | — | 100:0 | | 0 wt. % | 17.6 | 34.4 | 44.0 | 64.4 |
| Ex. 1 | | | | | | | | |
| Comp. | SCM6 | 65:35 | 825 | 60 wt. % | 11.9 | 27.6 | 39.6 | 56.1 |
| Ex. 2 | | | | smectite, 26 | | | | |
| | | | | wt. % illite | | | | |
| Comp. | LECA | 65:35 | 1150 | 82 wt. % | 10.7 | 16.9 | 22.9 | 41.7 |
| Ex. 3 | | | | smectite | | | | |

Table 1 shows that the compressive strengths of Examples 1 to 4 are comparable or are even higher than the compressive strengths as achieved by Comparative Examples 1 to 3.

### Cement Color Results

TABLE 2

| Ex. | RGB color data |
|---|---|
| Ex. 2 | 166, 148, 143 |
| Ex. 3 | 170, 140, 135 |
| Comp Ex. 1 | 145, 142, 140 |
| Comp Ex. 2 | 215, 159, 151 |
| Comp Ex. 3 | 223, 161, 145 |

Table 2 shows that concrete samples in accordance with Examples 2 and 3, which were prepared by methods in accordance with the present invention, do not show an unwanted discoloration and are comparable to a concrete sample according to Comparative Example 1. Comparative Example 2 and Comparative Example 3 even show an increase in R and G values, when compared to Examples 1 and 2.

1. A method for producing a supplementary cementitious material, comprising the steps of:
nodularizing a raw material of the supplementary cementitious material to produce nodules having an average particle size of 1 to 500 mm; and
calcining the nodules, wherein the calcining is conducted by passing gas, having a temperature in the range of 400 to 800°° C., through a bed of nodules, without the nodules becoming entrained in the gas.

2. The method according to claim 1, wherein the temperature of the gas is in the range of 400 to 600° C.; preferably in the range of 500 to 600° C., when the device is used for heat-treating solid material with more than 40 weight percent clay minerals pertaining to kaolin group; and/or in the range of in the range of 500 to 775° C., preferably in the range of 550 to 725° C., when the device is used for heat-treating solid material with more than 40 weight percent clay minerals pertaining to smectite group; and/or in the range of 600 to 800° C., preferably in the range of 700 to 800° C., when the device is used for heat-treating solid material with more than 40 weight percent clay minerals pertaining to illite group.

3. The method according to claim 1, wherein the bed of nodules is arranged in a vertical configuration and moves downwards due to gravity during the calcining step.

4. The method according to claim 3, wherein the movement of the bed of nodules is an isokinetic movement, wherein the nodules, in a cross-sectional view perpendicular to the movement direction, have the same displacement within a time period.

5. The method according to claim 4, wherein the gas passes the bed of nodules in a direction that is opposite to the movement direction of the bed of nodules, or wherein the gas passes the bed of nodules in a direction that is transversal to the movement direction of the bed of nodules.

6. The method according to claim 1, wherein the thickness of the bed of nodules is of 500 cm or less, preferably 250 cm or less, more preferable 100 cm or less.

7. The method according to claim 1, wherein the passing of the gas through the bed of nodules is conducted in a way that, in case of a movement of the bed of nodules, the gas to nodules ratio is 0.5:1.0 to 4.0:1.0 kg gas/kg nodules, preferably 1.0:1.0 to 3.0:1.0 kg gas/kg nodules, wherein the gas flow is determined in the exhaust gas with a pitot tube measurement or the like, and wherein the speed of the nodules is determined by weighing the nodules at the extraction point.

8. The method according to claim 1, wherein the raw material of the supplementary cementitious material, comprising at least one clay mineral, wherein the nodules are produced by crushing the raw material and subsequent nodularizing by a non-pressure nodularizer for nodularizing a dry material, such as disc pan pelletizer, a rotary drum pelletizer, a pin mixer, or by a pressure nodularizer for nodularizing a dry material, such as a briquetter or a compactor.

9. The method according to claim 1, wherein the raw material of the supplementary cementitious material is a wet sediment-like clay material, comprising at least one clay mineral that is present as agglomerates, having a primary average particle size of 10 μm or less and having a molecular water content of at least 2 wt. %, based on the total weight of the raw material of the supplementary cementitious material, wherein the nodules are produced by a non-pressure nodularizer for nodularizing a wet material, such as pug mill, or by a pressure nodularizer for nodularizing a wet material, such as a briquetter or a compactor.

10. The method according to claim 1, wherein the nodules have an average particle size of 2.5 to 400 mm, preferably 5 to 300 mm, more preferably 10 to 250 mm.

11. The method according to claim 1, wherein the method further comprises the step of crushing and/or sieving the raw material of the supplementary cementitious material prior to the nodularizing step, wherein the crushing is preferably conducted by a device selected from the group consisting of a roller press, a jaw crusher, a hammer rusher, a cone crusher, and a combination thereof.

12. The method according to claim 1, wherein the method further comprises a preheating step after the nodularizing step and prior to the calcination step, and/or wherein the method further comprises a cooling and/or heat recuperation step after the calcination step.

13. The method according to claim 1, wherein the method further comprises the step of milling the calcined nodules.

14. A method for producing a cement comprising milled cement clinker and a supplementary cementitious material,
wherein the supplementary cementitious material is produced by a method comprising the steps of
nodularizing a raw material of the supplementary cementitious material to produce nodules having an average particle size of 1 to 500 mm; and
calcining the nodules, wherein the calcining is conducted by passing gas, having a temperature in the range of 400 to 800° C., through a bed of nodules, without the nodules becoming entrained in the gas, and
wherein the milled cement clinker is produced by a clinkerization process, comprising the steps of calcining and subsequently milling a limestone-based raw material.

15. The method for producing a cement comprising milled cement clinker and a supplementary cementitious material according to claim 14, wherein the milling of the cement clinker is conducted separately or together with the milling of the supplementary cementitious material.
